(19) United States
(12) Patent Application Publication
(10) Pub. No.: US 2005/0205356 A1
(43) Pub. Date: Sep. 22, 2005

(54) Simplification of donning a safety harness and connecting a connecting element to the safety harness

(76) Inventor: Pastor Velasco JR., Stillwater, MN (US)

Correspondence Address: IPLM GROUP, P.A., POST OFFICE BOX 18455, MINNEAPOLIS, MN, 55418, US

(21) Appl. No.: 10/786,487

(22) Filed: Feb. 25, 2004

(51) Int. Cl. A62B 1/16

(52) U.S. Cl. 182/3

(57) ABSTRACT

A safety harness for use with a connecting device including a connecting element coded with a connecting element indicator includes an internal connection and an external connection. The internal connection has a first portion and a second portion. The first portion is coded with a first indicator, and the second portion is coded with a second indicator. The first indicator and the second indicator indicate that the first portion and the second portion are to be interconnected to create the internal connection. The external connection has a connecting member, and the connecting member is configured and arranged to operatively connect with the connecting element of the connecting device. The connecting member is coded with a third indicator, and the third indicator and the connecting element indicator indicate that the connecting member and the connecting element are to be interconnected to create the external connection.

### BACKGROUND OF THE INVENTION

1. Field of the Invention

The present invention relates a safety harness for which donning the safety harness and connecting a connecting element of a connecting device to the safety harness is simplified.

2. Description of the Prior Art

Various occupations place people in precarious positions at relatively dangerous heights thereby creating a need for fall protection assemblies. Among other things, such assemblies usually include at least one connecting device interconnected between a support structure and a person working in proximity to the support structure. The connecting device includes a connecting element, which is typically connected to a connecting member of a safety harness worn by the user. Obviously, such a safety harness must be designed to remain secure about the user in the event of a fall.

Various types of safety harnesses may be used for performing various types of tasks such as work positioning, restraint, suspension, rescue, personnel riding, climbing purposes, and fall protection. A safety harness may be used as a component of a work positioning system to support the user at a desired work position. A safety harness may be used as a component of a restraint system to prevent the user from reaching a fall hazard. Although the safety harness is not intended for use in extended suspension applications, it may be used in conjunction with a seat support such as a seat board, a suspension work seat, a seat sling, or a boatswain chair. A safety harness may also be used as a component of a rescue system, which will depend upon the type of rescue. A safety harness may be used as a component of a personnel riding system to suspend or transport the user vertically, and the personnel riding system typically includes a seat support and a back-up fall arrest system. A safety harness may be used as a component of a climbing system to prevent the user from falling when climbing a ladder or other climbing structure, and the climbing system typically includes a vertical cable or rail attached to the structure and a climbing sleeve.

One problem with donning a safety harness, even with the benefit of experience, is that it may be difficult to identify which buckle or buckle portion corresponds with which strap or mating buckle portion. Further, once the safety harness has been properly donned, another problem is that it may be difficult to determine which connecting device may be properly connected to which connecting member on the safety harness. Safety harnesses typically include several connecting members for various purposes, such as fall arrest, work positioning, restraint, suspension, rescue, riding, climbing, and connecting tools and other accessories. Although some connecting devices may be properly connected to more than one connecting member on the safety harness, which depends upon the task to be performed by the user, it may be improper to connect the connecting devices to some of the connecting members. There has been no simple way to communicate to the user the purposes of the various connecting members and the connecting devices, and this may be compounded by the complexity of the particular safety harness style, the frequency of use of the safety harness, and the possible language barriers. Therefore, there is a need for a more user-friendly safety harness.

### SUMMARY OF THE INVENTION

A preferred embodiment safety harness for use with a connecting device including a connecting element coded with a connecting element indicator includes an internal connection and an external connection. The internal connection has a first portion and a second portion. The first portion is coded with a first indicator, and the second portion is coded with a second indicator. The first indicator and the second indicator indicate that the first portion and the second portion are to be interconnected to create the internal connection. The external connection has a connecting member, and the connecting member is configured and arranged to operatively connect with the connecting element of the connecting device. The connecting member is coded with a third indicator, and the third indicator and the connecting element indicator indicate that the connecting member and the connecting element are to be interconnected to create the external connection.

A preferred embodiment fall protection assembly includes a connecting device and a safety harness. The connecting device includes a connecting element coded with a connecting element indicator. The safety harness includes an internal connection and an external connection. The internal connection has a first portion and a second portion. The first portion is coded with a first indicator, and the second portion is coded with a second indicator. The first indicator and the second indicator indicate that the first portion and the second portion interconnect to create the internal connection. The external connection has a connecting member configured and arranged to operatively connect with the connecting element of the connecting device. The connecting member is coded with a third indicator, and the third indicator and the connecting element indicator indicate that the connecting member and the connecting element interconnect to create the external connection.

A preferred embodiment method of donning a safety harness includes obtaining a safety harness. The safety harness includes an internal connection having a first portion and a second portion. The first portion is coded with a first indicator, and the second portion is coded with a second indicator. The first indicator of the first portion is matched with the second indicator of the second portion, and the first portion and the second portion are interconnected to secure and don the safety harness.

A preferred embodiment method of connecting a connecting device to a safety harness includes obtaining a safety harness. The safety harness includes an external connection having a connecting member coded with a first indicator. A connecting device including a connecting element coded with a connecting element indicator is obtained. The first indicator is matched with the connecting element indicator, and the connecting member of the safety harness and the connecting element of the connecting device are interconnected.

A preferred embodiment safety harness for use with a connecting device including a connecting element coded with a connecting element indicator includes a first shoulder strap, a second shoulder strap, a first leg strap, a second leg strap, and a dorsal pad assembly. The first shoulder strap is configured and arranged to fit about a first shoulder of a user, and the second shoulder strap is configured and arranged to fit about a second shoulder of the user. The first leg strap is configured and arranged to fit about a first leg of the user, and the second leg strap is configured and arranged to fit about a second leg of the user. The dorsal pad assembly interconnects the first shoulder strap and the second shoulder strap proximate a back of the user. The dorsal pad assembly includes a D-ring configured and arranged to operatively connect with the connecting element of the connecting device. The D-ring is coded with a D-ring indicator, and the D-ring indicator and the connecting element indicator indicate that the D-ring and the connecting element are to be interconnected.

### BRIEF DESCRIPTION OF THE DRAWINGS

FIG. 1 is a rear view of a safety harness constructed according to the principles of the present invention;

FIG. 2 is a rear view of another embodiment safety harness constructed according to the principles of the present invention;

FIG. 3A is a side view of a positioning lanyard constructed according to the principles of the present invention for use with the safety harnesses shown in FIGS. 1 and 2;

FIG. 3B is a side view of another embodiment positioning lanyard constructed according to the principles of the present invention for use with the safety harnesses shown in FIGS. 1 and 2;

FIG. 3C is a side view of another embodiment positioning lanyard constructed according to the principles of the present invention for use with the safety harnesses shown in FIGS. 1 and 2;

FIG. 4 is a side view of a Y-lanyard constructed according to the principles of the present invention for use with the safety harnesses shown in FIGS. 1 and 2;

FIG. 5 is a side view of a chain rebar assembly constructed according to the principles of the present invention for use with the safety harnesses shown in FIGS. 1 and 2;

FIG. 6 is a side view of a fall arrest lanyard constructed according to the principles of the present invention for use with the safety harnesses shown in FIGS. 1 and 2;

FIG. 7 is a side view of a restraint lanyard constructed according to the principles of the present invention for use with the safety harnesses shown in FIGS. 1 and 2;

FIG. 8 is a side view of a D-ring extension lanyard constructed according to the principles of the present invention for use with the safety harnesses shown in FIGS. 1 and 2;

FIG. 9 is a side view of a shock absorber device constructed according to the principles of the present invention for use with the safety harnesses shown in FIGS. 1 and 2;

FIG. 10 is a side view of a rope adjuster lanyard constructed according to the principles of the present invention for use with the safety harnesses shown in FIGS. 1 and 2;

FIG. 11 is a side view of a controlled descent device constructed according to the principles of the present invention for use with the safety harnesses shown in FIGS. 1 and 2;

FIG. 12 is a front view of a self-retracting lifeline constructed according to the principles of the present invention for use with the safety harnesses shown in FIGS. 1 and 2;

FIG. 13 is a front view of a rescue positioning device constructed according to the principles of the present invention for use with the safety harnesses shown in FIGS. 1 and 2; and

FIG. 14 is a perspective view of a winch support and rescue device constructed according to the principles of the present invention for use with the safety harnesses shown in FIGS. 1 and 2.

### DETAILED DESCRIPTION OF A PREFERRED EMBODIMENT

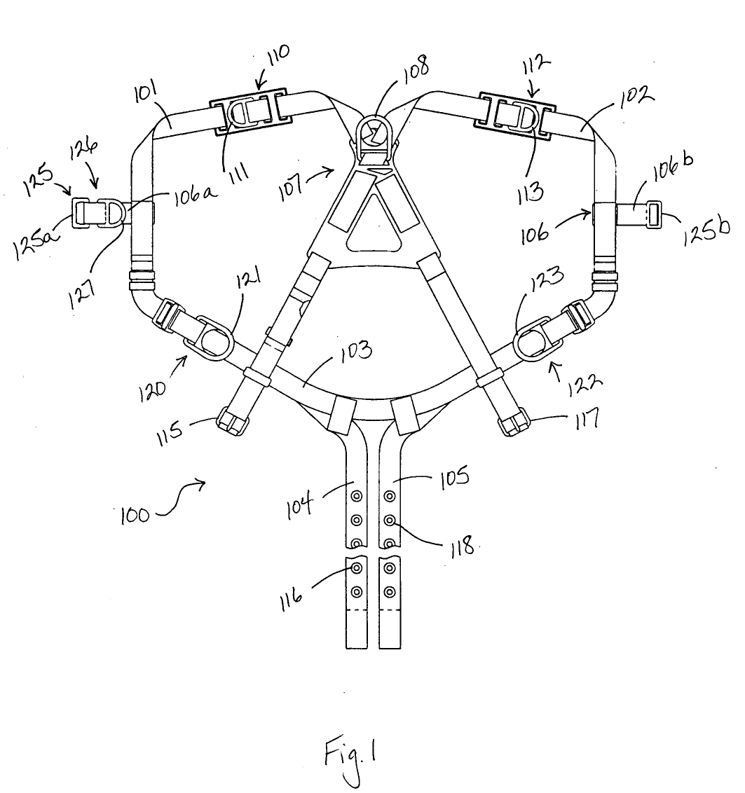

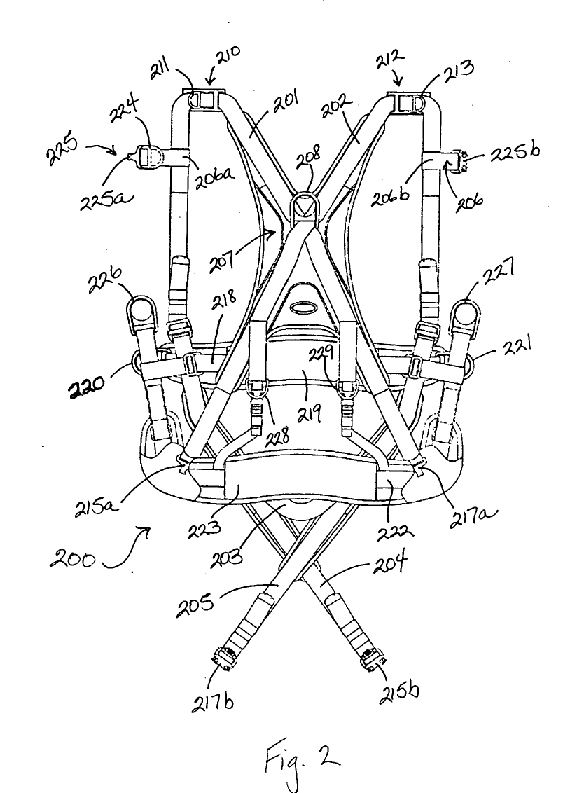

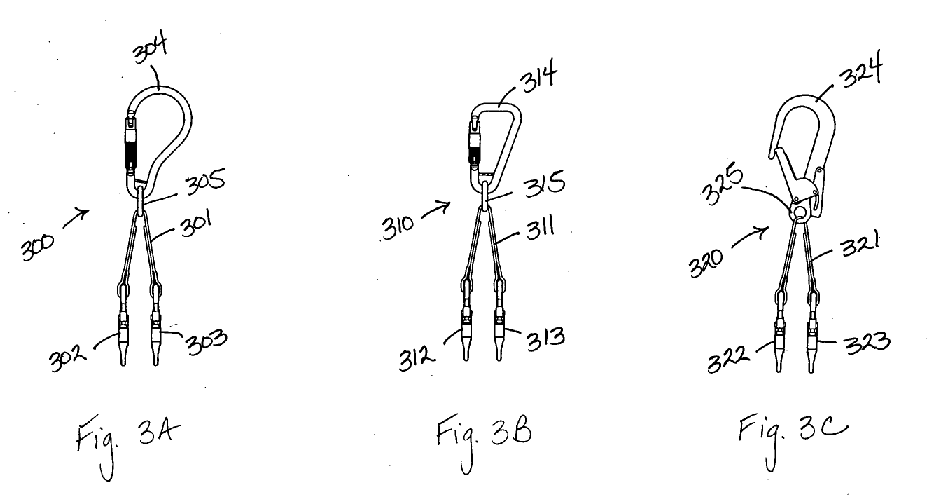

A preferred embodiment fall protection assembly constructed according to the principles of the present invention includes a safety harness, designated by the numerals 100 and 200 in FIGS. 1 and 2, respectively, and a connecting device, examples of which are shown in FIGS. 3A-14. The connecting device interconnects the safety harness and a support structure. The connecting device includes a connecting element, which is configured and arranged to operatively connect with a connecting member on the safety harness.

Generally, the safety harnesses 100 and 200 include internal connections and external connections. Each internal connection includes a first portion and a second portion that are configured and arranged to be interconnected to create the internal connection. The first portion is preferably a buckle or a buckle portion and the second portion is preferably a strap or a mating buckle portion. It is understood that the first portion and the second portion may be interchanged. The buckle or the buckle portion connects with the strap or the mating buckle portion to secure the safety harness about the user thereby allowing the user to don the safety harness. The strap may include grommets through which a buckle tongue is inserted to engage the strap. There are many different types of buckles that may be used including but not limited to tongue buckles, parachute buckles, pass-thru buckles, and quick-connect buckles.

Each portion of the internal connection is coded with an indicator indicating that it is to be interconnected with the corresponding portion to create the internal connection. For example, each corresponding portion of each internal connection could be coded with a matching indicator such as a symbol, a color, a lock-out device such as different types of buckles or buckle portions that will only connect to the desired straps or mating buckle portions, or any other suitable indicator known in the art. The indicators could be placed directly on each portion by etching or by color plating, and/or the indicators could be placed on a label or a sticker affixed to each portion.

Each external connection includes a connecting member on the safety harness such as a D-ring that is configured and arranged to be interconnected with a connecting element on connecting device to create the external connection. The connecting device may be a lanyard, a lifeline, a load arrestor, a rope grab, an anchorage connector, a ladder safety system, a confined space and rescue system, a connecting tool, or an accessory. It is recognized that there are many suitable types of connecting devices known in the art that could be used with the present invention. The possible connecting devices may be components of different types of fall protection assemblies such as fall arrest, work positioning, restraint, suspension, and rescue systems. It is important to ensure that the connecting devices and their connecting elements are compatible in size, shape, and strength with the appropriate connecting members of the safety harness.

Similarly, each connecting member of the safety harness is coded with an indicator and each corresponding connecting element of a connecting device is coded with a matching connecting element indicator. The matching indicators on the connecting member and the connecting element indicate that they are to be interconnected to create the external connection. For example, the matching indicators could be a symbol, a color, a lock-out device, or any other suitable indicator known in the art. The matching indicators could be placed directly on each component by etching or by color plating, and/or the indicators could be placed on a label or a sticker affixed to each component.

The safety harness 100, as shown in FIG. 1, includes a first shoulder strap 101, a second shoulder strap 102, a seat strap 103, a first leg strap 104, a second leg strap 105, and a chest strap 106. The first shoulder strap 101 and the second shoulder strap 102 criss-cross and overlap in divergent fashion at a junction in the back of the safety harness 100, and a dorsal pad assembly 107 including a D-ring 108 interconnects the shoulder straps 101 and 102 proximate the junction. The first shoulder strap 101 includes a first shoulder pad assembly 110 with a first shoulder D-ring 111, and the second shoulder strap 102 includes a second shoulder pad assembly 112 with a second shoulder D-ring 113.

The seat strap 103 interconnects the front ends of the shoulder straps 101 and 102, and the leg straps 104 and 105 are operatively connected to the seat strap 103 proximate a middle portion thereof. Proximate the junction of the seat strap 103 and the first shoulder strap 101, a first seat attachment assembly 120 including a first side D-ring 121 is operatively connected to the seat strap 103. Proximate the junction of the seat strap 103 and the second shoulder strap 102, a second seat attachment assembly 122 including a second side D-ring 123 is operatively connected to the seat strap 103.

The first leg strap 104 includes grommets 116, and the second leg strap 105 includes grommets 118. The leg straps 104 and 105 are configured and arranged to operatively connect with the ends of the shoulder straps 101 and 102 proximate the back of the safety harness 100. The first shoulder strap 101 includes a buckle 117 configured and arranged to engage the grommets 118 of the second leg strap 105. The second shoulder strap 102 includes a buckle 115 configured and arranged to engage the grommets 116 of the first leg strap 104.

The chest strap 106 includes a first strap 106a and a second strap 106b, and the chest strap 106 interconnects the shoulder straps 101 and 102 proximate the front of the safety harness 100 with a buckle 125. A first buckle portion 125a is operatively connected to the first strap 106a and a second buckle portion 125b is operatively connected to the second strap 106b. The first buckle portion 125a and the second buckle portion 125b interconnect the straps 106a and 106b of the chest strap 106. A chest attachment assembly 126 including a chest D-ring 127 is operatively connected to the chest strap 106 proximate the buckle 125. An example of a similar safety harness is the DELTA NO-TANGLE™ safety harness by D B Industries, Inc. of Red Wing, Minn.

To don the safety harness 100, indicators coded on each of the corresponding portions of each of the internal connections are used to match and interconnect the corresponding portions to create each internal connection. More specifically, once the user has placed the shoulder straps 101 and 102 about each respective shoulder, the indicators on the first buckle portion 125a and the second buckle portion 125b are matched and the buckle 125 is interconnected. Then, the user places the first leg strap 104 about the user's left leg and matches the indicator on the first leg strap 104 and/or on the grommets 116 with the indicator on the buckle 115. Finally, the user places the second leg strap 105 about the user's right leg and matches the indicator on the second leg strap 105 and/or on the grommets 118 with the indicator on the buckle 117. For example, the buckle portions 125a and 125b could be coded with the color red, the first leg strap 104 and/or the grommets 116 and the buckle 115 could be coded with the color green, and the second leg strap 105 and/or the grommets 118 and the buckle 117 could be coded with the color blue.

The safety harness 200, as shown in FIG. 2, includes a first shoulder strap 201, a second shoulder strap 202, a seat strap 203, a first leg strap 204, a second leg strap 205, and a chest strap 206. The safety harness 200 also includes a waist belt 218 and a seat sling 222.

The first shoulder strap 201 and the second shoulder strap 202 criss-cross and overlap in divergent fashion at a junction in the back of the safety harness 200, and a dorsal pad assembly 207 including a D-ring 208 interconnects the shoulder straps 201 and 202 proximate the junction. The first shoulder strap 201 includes a first shoulder pad assembly 210 with a first shoulder D-ring 211, and the second shoulder strap 202 includes a second shoulder pad assembly 212 with a second shoulder D-ring 213. The ends of the shoulder straps 201 and 202 in the back of the safety harness 200 include buckle portions. The first shoulder strap 201 includes a first buckle portion 217a, and the second shoulder strap 202 includes a first buckle portion 215a.

The seat strap 203 interconnects the front ends of the shoulder straps 201 and 202, and the leg straps 204 and 205 are operatively connected to the seat strap 203 proximate a middle portion thereof. At the ends opposite the seat strap 203, the first leg strap 204 includes a second buckle portion 215b and the second leg strap 205 includes a second buckle portion 217b. The second buckle portion 215b is configured and arranged to interconnect with the first buckle portion 215a, and the second buckle portion 217b is configured and arranged to interconnect with the first buckle portion 217a. In other words, the leg straps 204 and 205 are configured and arranged to operatively connect with the ends of the shoulder straps 201 and 202 proximate the back of the safety harness 200 via the buckles.

The waist belt 218 preferably spans the back of the safety harness 200 proximate the waist of the user and is operatively connected to the seat strap 203 proximate the junctions of each shoulder strap 201 and 202 with the seat strap 203. A hip pad 219 is operatively connected to the waist belt 218 to provide added comfort to the safety harness 200. A hip D-ring 220 is operatively connected to the waist belt 218 proximate the first shoulder strap 201 and a hip D-ring 221 is operatively connected to the waist belt 218 proximate the second shoulder strap 202.

The seat sling 222 preferably also spans the back of the safety harness 200 proximate the seat of the user, below the waist belt 218. The seat sling 222 is operatively connected to the waist belt 218 proximate the ends of the waist belt 218 and proximate a middle portion of the waist belt 218. A seat sling pad 223 is operatively connected to the seat sling 222 to provide added comfort to the safety harness 200. A seat attachment ring 226 is operatively connected to the seat sling 222 proximate the first shoulder strap 201 and a seat attachment ring 227 is operatively connected to the seat sling 222 proximate the second shoulder strap 202. The side D-rings of the safety harness 200 include the hip D-rings 220 and 221 and the seat attachment rings 226 and 227. Typically, the hip D-rings 220 and 221 are used either individually or as a pair and the seat attachment rings 226 and 227 are used as a pair.

The safety harness 200 may also include tool rings to which tools may be connected. A tool ring 228 is operatively connected to the strap interconnecting the waist strap 218 and the seat sling 222 proximate the waist strap 218 and the second shoulder strap 202, and a tool ring 229 is operatively connected to the strap interconnecting the waist strap 218 and the seat sling 222 proximate the waist strap 218 and the first shoulder strap 201.

The chest strap 206 includes a first strap 206a and a second strap 206b, and the chest strap 206 interconnects the shoulder straps 201 and 202 proximate the front of the safety harness 200 with a buckle 225. A first buckle portion 225a is operatively connected to the first strap 206a and a second buckle portion 225b is operatively connected to the second strap 206b. The first buckle portion 225a and the second buckle portion 225b interconnect the straps 206a and 206b of the chest strap 206. A front D-ring 224 is operatively connected to the chest strap 206 proximate the buckle 225. An example of a similar safety harness is the EXOFIT™ tower climbing safety harness by D B Industries, Inc. of Red Wing, Minn.

To don the safety harness 200, indicators coded on each of the corresponding portions of each of the internal connections are used to match and interconnect the corresponding portions to create each internal connection. More specifically, once the user has placed the shoulder straps 201 and 202 about each respective shoulder, the indicators on the first buckle portion 225a and the second buckle portion 225b are matched and the buckle 225 is interconnected. Then, the user places the first leg strap 204 about the user's left leg and matches the indicator on the second buckle portion 215b operatively connected to the first leg strap 204 with the indicator on the first buckle portion 215a. Finally, the user places the second leg strap 205 about the user's right leg and matches the indicator on the second buckle portion 217b operatively connected to the second leg strap 205 with the indicator on the first buckle portion 217a. For example, the buckle portions 225a and 225b could be coded with a triangular symbol, the buckle portions 215a and 215b could be coded with a square symbol, and the buckle portions 217a and 217b could be coded with a circular symbol. Similar indicators could also be used to indicate interconnection of the waist belt 218 and the seat sling 222 should they become disconnected from the safety harness 200.

After the internal connections have been created to secure the safety harness about the user, the user may also establish external connections with the connecting members of the safety harness to a connecting element of a connecting device. Connecting members of the safety harness 100 include the dorsal D-ring 108, the front D-ring 127, the side D-rings 121 and 123, and the shoulder D-rings 111 and 113. Connecting members of the safety harness 200 include the dorsal D-ring 208, the front D-ring 224, the side D-rings 220, 221, 226, and 227, the shoulder D-rings 211 and 213, and the tool rings 228 and 229. The safety harness connecting members could be D-rings, rings, web loops, or other types of connecting members well known in the art. These harnesses and connecting members are illustrative and are not exhaustive, and it is recognized that different types of harnesses may include different types of connecting members for use with different types of connecting devices.

The present invention includes coding the connecting members of the safety harness and corresponding connecting elements of the connecting devices in some fashion so that it is obvious to the user how the components interconnect. The connecting elements could include snap hooks, carabiners, and other types of connectors well known in the art. Coding could be by using colors or symbols on the corresponding interconnecting components and/or by using lock-out mechanisms such as different types of connectors that will only connect to the desired mating connectors. Even further, the connector such as a hook on connecting device such as self-retracting lifeline or a lanyard could be coded to match a fall arrest anchorage point such as an eyebolt, a trolley, a beam slider, etc.

In addition, coding the connecting members and/or the connecting elements to identify the intended purpose could also be done. In other words, using indicators to indicate work positioning, restraint, suspension, rescue, personnel riding, climbing purposes, fall protection, and tool and accessory purposes could be done. For example, fall protection could be coded with the color orange, rescue could be coded with the color yellow, and etc.

More specifically, the connecting members serve different functions depending upon their locations on the safety harness. Generally, the connecting members serve as anchorage points for the connecting devices. Some connecting members may also be used for connecting tools and accessories. Typically the connecting members are D-rings. The front D-rings are used to connect the safety harness to a ladder safety system or to connecting devices for work positioning, suspension, and rescue, which are classified under the Canadian Standards Association (hereinafter “CSA”) as Group L or D. The side D-rings are used for positioning or restraint, such as with a rebar lanyard assembly or a wall form hook assembly, which are classified under the CSA as Group P. They can also be used to hold a tool. For example, the seat attachment D-rings could be coded to match a lifting device connector and the hip D-rings could be color coded to match a work positioning lanyard. The dorsal D-rings are used for fall protection or restraint, which are classified under the CSA as Group A. Some styles of safety harnesses have dorsal D-rings that slide on impact, keeping the user in an upright position and providing added safety and comfort. The shoulder D-rings are typically connected to a Y-type lanyard with a spreader bar for rescue and retrieval operations in confined spaces, which are classified under the CSA as Group E. The optional tool rings on the harness could be color coded to indicate use for tools only.

Table 1 shows which typical connecting devices may be attached to which connecting members of the safety harness. Examples of such connecting devices are listed by part number for products manufactured and distributed by D B Industries, Inc. of Red Wing, Minn. These examples of connecting devices are for illustrative purposes only and are not exhaustive. It is recognized that other connecting devices well known in the art may also be used.

TABLE 1
Connecting Members for External Connections and
Typical Corresponding Connecting Devices

| Connecting | Typical Corresponding | Example |
|---|---|---|
| Members | Connecting Devices | Part Number |
| Dorsal D-Ring | D-Ring Extension | 1201117 |
| | Lifeline (Self-Retracting Lifeline, | 3403400, |
| | Horizontal Lifeline) | 7600020 |
| | Lanyard (Fall Arrest, Restraint) | 1220006, |
| | | 1202354 |
| | Shock Absorber | 1220362 |
| | Winch | 8101000 |
| | Rope Grab | 1224005 |
| | Carabiner | 2000108 |
| | Descent Device (Rescue Positioning | 3600000, |
| | Device, Controlled Descent Device) | 3300000 |
| Front D-Ring | Carabiner (Work Positioning, Ladder | 2000108 |
| | Safety) | |
| | Descent Device (Rescue Positioning | 3600000, |
| | Device, Controlled Descent Device) | 3300000 |
| | Lanyard (Restraint) | 1202354 |
| Side D-Rings | Lanyard (Work Positioning, Restraint) | 5900050, |
| | | 1202354 |
| | Carabiner | 2000108 |
| | Descent Device (Rescue Positioning | 3600000 |
| | Device) | |
| Shoulder D-Rings | Lanyard (Y-Lanyard, Rescue | 1201460 |
| | Positioning) | |
| | Carabiner | 2000108 |

There are numerous typical connecting devices that may be connected to the connecting members of the harnesses as external connections of the safety harness. FIGS. 3A, 3B, and 3C show possible positioning lanyards that may be used. Positioning lanyards are typically used to hold and sustain the user at a specific work location and limit free fall to two feet or less. In FIG. 3A, positioning lanyard 300 includes a strap 301 with a hook 302 on one end and a hook 303 on the other end. The hooks 302 and 303 are preferably snap-hooks and are the connecting elements of the positioning lanyard 300. The hooks 302 and 303 are coded with connecting element indicators to match the indicators on the connecting members of the safety harness, for example side D-rings 121 and 123 on safety harness 100 and side D-rings 220 and 221 or 226 and 227 on safety harness 200. A carabiner 304 is operatively connected with a ring 305 proximate the middle of the strap 301, and the carabiner 304 connects to an anchorage member.

In FIG. 3B, positioning lanyard 310 includes a strap 311 with a hook 312 on one end and a hook 313 on the other end. The hooks 312 and 313 are preferably snap-hooks and are the connecting elements of the positioning lanyard 310. The hooks 312 and 313 are coded with connecting element indicators to match the indicators on the connecting members of the safety harness, for example side D-rings 121 and 123 on safety harness 100 and side D-rings 220 and 221 or 226 and 227 on safety harness 200. A carabiner 314 is operatively connected with a ring 315 proximate the middle of the strap 311, and the carabiner 314 connects to an anchorage member.

In FIG. 3C, positioning lanyard 320 includes a strap 321 with a hook 322 on one end and a hook 323 on the other end. The hooks 322 and 323 are preferably snap-hooks and are the connecting elements of the positioning lanyard 320. The hooks 322 and 323 are coded with connecting element indicators to match the indicators on the connecting members of the safety harness, for example side D-rings 121 and 123 on safety harness 100 and side D-rings 220 and 221 or 226 and 227 on safety harness 200. A carabiner 324 includes a ring portion 325 through which the middle of the strap 321 is positioned, and the carabiner 324 connects to an anchorage member.

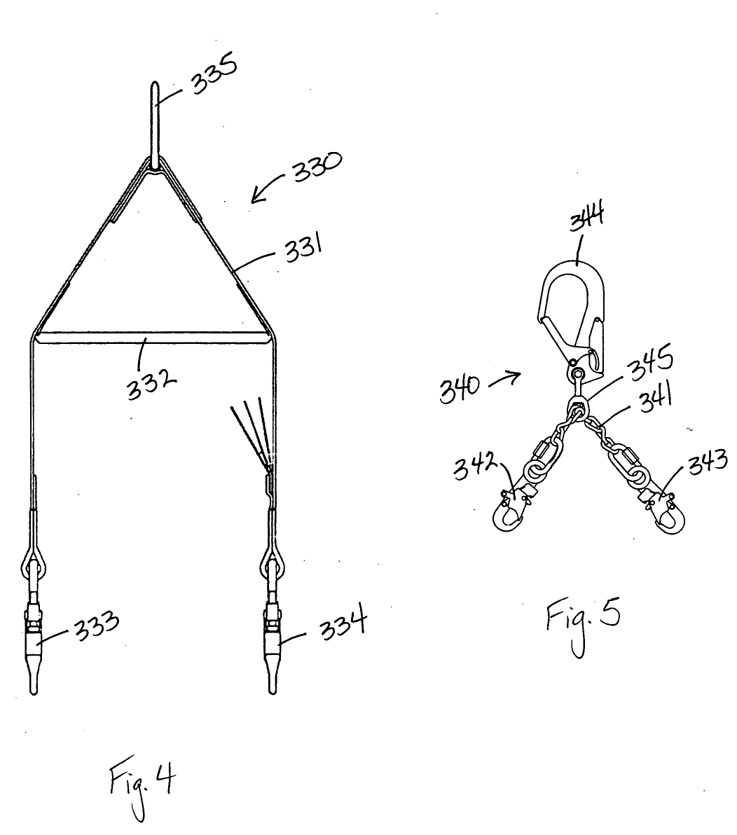

FIG. 4 shows a Y-lanyard 330 including a strap 331, which is preferably made of webbing, with a snap hook 333 on one end and a snap hook 334 on the other end. A D-ring 335 is operatively connected proximate the middle of the strap 331, and a spreader bar 332 is operatively connected to the strap 331 between the D-ring 335 and the snap hooks 333 and 334. The snap hooks 333 and 334 are the connecting elements of the Y-lanyard 330, and the D-ring 335 is connected to an anchorage member. The snap hooks 333 and 334 are coded with connecting element indicators to match the indicators on the connecting members of the safety harness, for example the shoulder D-rings 111 and 113 on safety harness 100 and the shoulder D-rings 211 and 213 on safety harness 200.

FIG. 5 shows a chain rebar assembly 340, which is another type of work positioning connecting device, including a chain 341 with a snap hook 342 on one end and a snap hook 343 on the other end. A wall form hook 344 is operatively connected proximate the middle of the chain 341 with a ring portion 345 of the wall form hook 344. The snap hooks 342 and 343 are the connecting elements of the chain rebar assembly 340, and the wall form hook 344 connects to an anchorage member, a wall form. The snap hooks 342 and 343 are coded with connecting element indicators to match the indicators on the connecting members of the safety harness, for example side D-rings 121 and 123 on safety harness 100 and side D-rings 220 and 221 or 226 and 227 on safety harness 200.

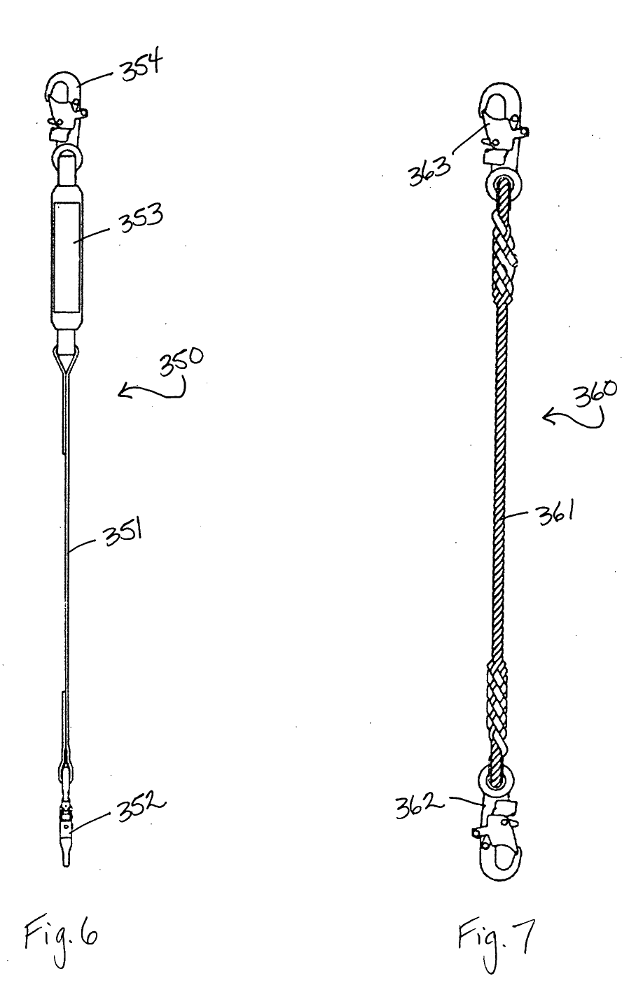

FIG. 6 shows a fall arrest lanyard 350 including webbing 351 with a hook 352 on one end and a shock absorber 353 and a hook 354 on the other end. The hook 354 is the connecting element of the fall arrest lanyard 350, and the hook 352 connects to an anchorage member. The hook 354 is coded with a connecting element indicator to match the indicator on the connecting member of the safety harness, for example the dorsal D-ring 108 on safety harness 100 and the dorsal D-ring 208 on safety harness 200.

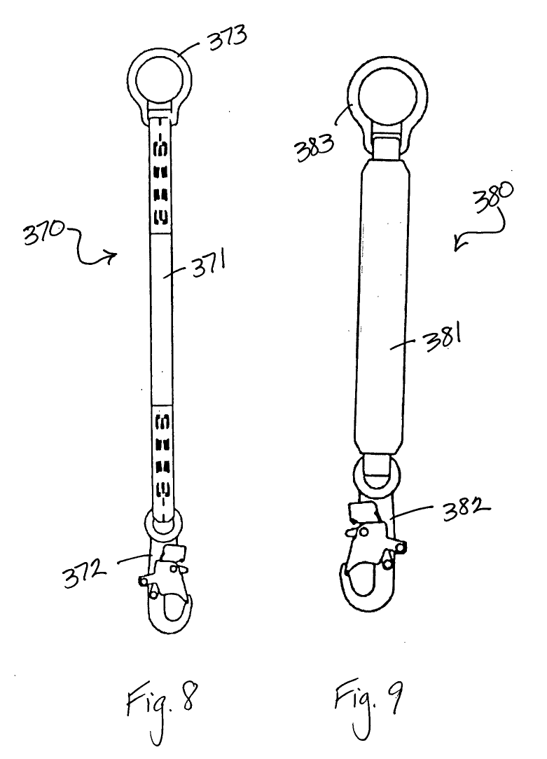

FIG. 7 shows a restraint lanyard 360 including a rope 361 with a hook 362 at one end and a hook 363 at the other end. One of the hooks is the connecting element of the restraint lanyard 360, and the other hook connects to an anchorage member. Either hook 362 or hook 363 is coded with a connecting element indicator to match the indicator on the connecting member of the safety harness, for example the dorsal D-ring 108, the front D-ring 127, or a side D-ring 121 or 123 of safety harness 100 and the dorsal D-ring 208, the front D-ring 224, or a side D-ring 220, 221, 226, or 227 of safety harness 200.

FIG. 8 shows a D-ring extension lanyard 370 including webbing 371 with a hook 372 at one end and a ring 373 at the other end. The hook 372 is the connecting element of the D-ring extension lanyard 370, and the ring 373 connects to an anchorage member with a connector well known in the art. The hook 372 is coded with a connecting element indicator to match the indicator on the connecting member of the safety harness, for example the dorsal D-ring 108 of safety harness 100 and the dorsal D-ring 208 of safety harness 200.

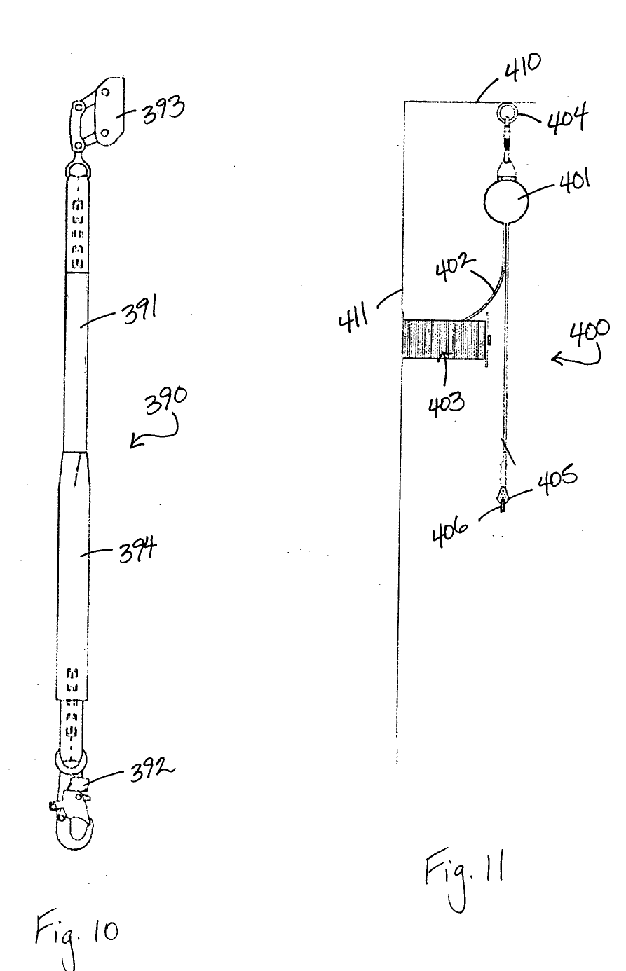

FIG. 9 shows a shock absorber device 380 including a shock absorber 381 with a hook 382 at one end and a ring 383 at the other end. The hook 382 is the connecting element of the shock absorbing lanyard 380, and the ring 383 connects to an anchorage member with a connector device such as a lanyard or other device well known in the art. The hook 382 is coded with a connecting element indicator to match the indicator on the connecting member of the safety harness, for example the dorsal D-ring 108 of safety harness 100 and the dorsal D-ring 208 of safety harness 200.

FIG. 10 shows a rope adjuster lanyard 390 including webbing 391 with a hook 392 at one end and a rope grab 393 at the other end. A shock absorber 394 is operatively connected to the webbing 391 proximate the hook 392. The hook 392 is the connecting element of the rope adjuster lanyard 390, and the rope grab 393 is operatively connected to an anchorage member, a rope. The hook 392 is coded with a connecting element indicator to match the indicator on the connecting member of the safety harness, for example the dorsal D-ring 108 of safety harness 100 and the dorsal D-ring 208 of safety harness 200.

FIG. 11 shows a controlled descent device 400 including a pulley 401, a rope 402, and a spool and spindle assembly 403. The pulley is operatively connected to an anchorage member 410 with a ring 404, and the spool and spindle assembly 403 is operatively connected to a mounting surface 411. The rope 402 is wound around the spool and spindle assembly 403 proximate one end of the rope 402 and then positioned through the pulley 401. The other end of the rope 402 includes a loop 405 operatively connected to a carabiner 406, which is the connecting element of the controlled descent device 400. The carabiner 406 is coded with a connecting element indicator to match the indicator on the connecting member of the safety harness, for example a front D-ring 127 or a dorsal D-ring 108 of harness 100 or a front D-ring 224 or a dorsal D-ring 208 of harness 200. An example of a suitable controlled descent device is the RESCUMATIC™ Automatic Descent Controller by D B Industries, Inc. of Red Wing, Minn.

FIG. 12 shows a self-retracting lifeline 500 including a housing 501 with a hook 502 and a cable 503 with a hook 504. The hook 504 is the connecting element of the self-retracting lifeline 500, and the hook 502 is connected to an anchorage member. The hook 504 is coded with a connecting element indicator to match the indicator on the connecting member of the safety harness, for example dorsal D-ring 108 of safety harness 100 and dorsal D-ring 208 of safety harness 200. Examples of suitable self-retracting lifelines are the ULTRA-LOK™ self-retracting lifeline and the TALON™ self-retracting lifeline by D B Industries, Inc. of Red Wing, Minn.

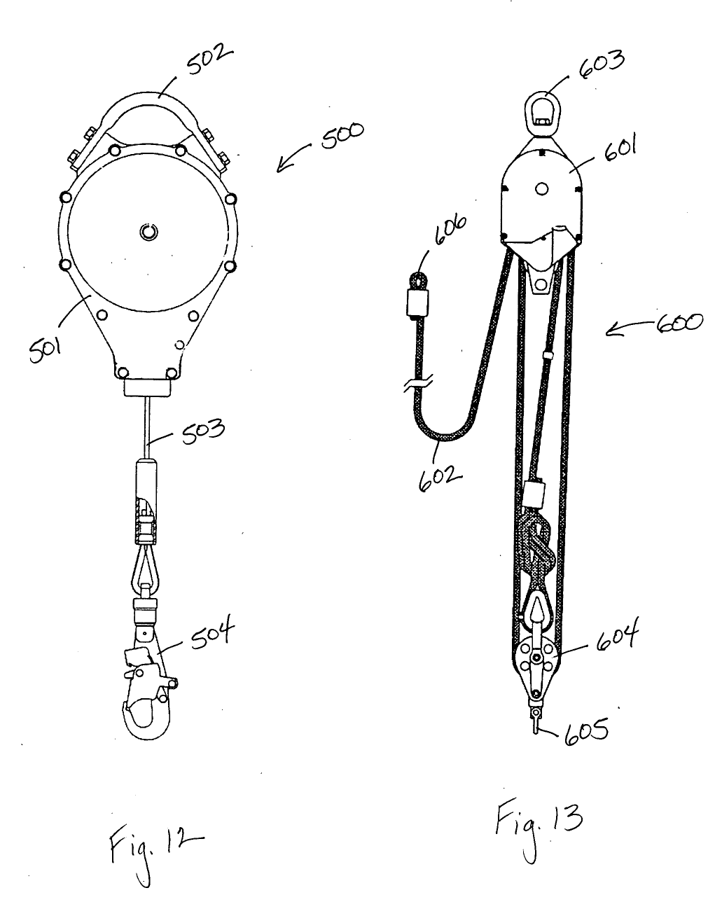

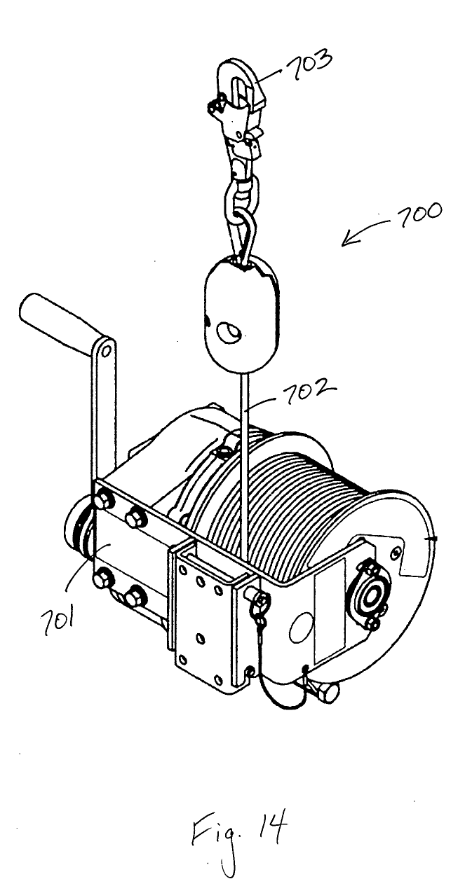

FIG. 13 shows a rescue positioning device 600 including a pulley 601, a rope 602, and a pulley 604. A hook 603 operatively connected to the pulley 601 connects the pulley 601 to an anchorage member. An intermediate portion of the rope 602 is positioned through the pulley 601 and the pulley 604, and an end portion of the rope 602 is connected to the pulley 604. A hook 605 operatively connected to the pulley 604 is the connecting element of the rescue positioning device 600. Typically, the hook 605 is coded with a connecting element indicator to match an indicator on a D-ring of a Y-lanyard such as D-ring 335 of Y-lanyard 330 in FIG. 4. The snap hooks on the Y-lanyard such as snap hooks 333 and 334 in FIG. 4 are the connecting elements of the Y-lanyard and are coded with connecting element indicators to match the indicators on the connecting members of the safety harness, for example the shoulder D-rings 111 and 113 on safety harness 100 and the shoulder D-rings 211 and 213 on safety harness 200. The other end of the rope 602 includes a loop 606, which is used for operation of the device 600 to raise and lower the person connected to hook 605.

FIG. 14 shows a winch support and rescue device 700 including a winch 701, a cable 702, and a hook 703. The hook 703 is the connecting element of the winch support and rescue device 700. The hook 703 may be coded with a connecting element indicator to match the indicator on the connecting member of the safety harness, such as the dorsal D-ring 108 of harness 100 and the dorsal D-ring 208 of harness 200. In addition, the hook 703 may be coded with a connecting element indicator to match an indicator on a D-ring of a Y-lanyard such as D-ring 335 of Y-lanyard 330 in FIG. 4. The snap hooks on the Y-lanyard such as snap hooks 333 and 334 in FIG. 4 are the connecting elements of the Y-lanyard and are coded with connecting element indicators to match the indicators on the connecting members of the safety harness, for example the shoulder D-rings 111 and 113 on safety harness 100 and the shoulder D-rings 211 and 213 on safety harness 200.

Possible external connections may also include using the connecting members on the safety harnesses for temporarily attaching a hook at the opposite end of a self-retracting lifeline or a lanyard, which connects to anchorage points, when not in use. Further, connecting members may be used for attaching work tools, water bottles, and other accessories.

The examples included herein are illustrative and are not exhaustive. In addition to the two types of safety harnesses shown in FIGS. 1 and 2, it is recognized that other types of safety harnesses may be used. It is also recognized that there are other types of connecting members and connecting devices well known in the art that are also within the scope of the present invention.

The above specification, examples and data provide a complete description of the manufacture and use of the composition of the invention. Since many embodiments of the invention can be made without departing from the spirit and scope of the invention, the invention resides in the claims hereinafter appended.

1. A safety harness having straps for use with a connecting device including a connecting element being coded with a connecting element indicator, comprising:
a) an internal connection of the safety harness having a first portion and a second portion, said first portion being coded with a first indicator, said second portion being coded with a second indicator, said first indicator and said second indicator indicating that said first portion and said second portion are to be interconnected to create said internal connection, said internal connection connecting the straps of the safety harness; and
b) an external connection portion of the safety harness having a connecting member, said connecting member being configured and arranged to operatively connect with the connecting element of the connecting device, said connecting member being coded with a third indicator, said third indicator and the connecting element indicator indicating that said connecting member and the connecting element are to be interconnected to create an external connection, said external connection portion being connectable to the connecting element of the connecting device thereby creating the external connection between the connecting member of the safety harness and the connecting element of the connecting device.

2. The safety harness of claim 1, wherein said first portion is a buckle and said second portion is a strap.

3. The safety harness of claim 1, wherein said first portion is a first buckle portion and said second portion is a second buckle portion, said first buckle portion mating with said second buckle portion.

4. The safety harness of claim 1, wherein said connecting member is a D-ring.

5. A fall protection assembly, comprising:
a) a connecting device including a connecting element being coded with a connecting element indicator; and
b) a safety harness including an internal connection and an external connection, said internal connection having a first portion and a second portion, said first portion being coded with a first indicator, said second portion being coded with a second indicator, said first indicator and said second indicator indicating that said first portion and said second portion interconnect to create said internal connection, said external connection having a connecting member, said connecting member being configured and arranged to operatively connect with said connecting element of said connecting device, said connecting member being coded with a third indicator, said third indicator and said connecting element indicator indicating that said connecting member and said connecting element interconnect to create said external connection.

6. The fall protection assembly of claim 5, wherein said first portion is a buckle and said second portion is a strap.

7. The fall protection assembly of claim 5, wherein said first portion is a first buckle portion and said second portion is a second buckle portion, said first buckle portion mating with said second buckle portion.

8. The fall protection assembly of claim 5, wherein said connecting member is a D-ring.

9. The fall protection assembly of claim 5, wherein said connecting device is a device selected from the group consisting of a lanyard, a lifeline, a rope grab, a rebar assembly, a controlled descent device, a rescue positioning device, and a winch.

10. The fall protection assembly of claim 5, wherein said connecting element is a carabiner or a hook.

11. A method of donning a safety harness, comprising:
a) obtaining a safety harness including an internal connection having a first portion and a second portion, the first portion being coded with a first indicator, the second portion being coded with a second indicator;
b) matching the first indicator of the first portion with the second indicator of the second portion;
c) interconnecting the first portion and the second portion to secure and don the safety harness;
d) obtaining a connecting device including a connecting element being coded with a connecting element indicator;
e) matching a third indicator of a connecting member of the safety harness with the connecting element indicator of the connecting element; and
f) interconnecting the connecting member and the connecting element to secure the connecting device to the safety harness.

12. (canceled)

13. A method of connecting a connecting device to a safety harness, comprising:
a) obtaining a safety harness including an external connection having a connecting member being coded with a first indicator;
b) obtaining a connecting device including a connecting element being coded with a connecting element indicator;
c) matching the first indicator with the connecting element indicator; and
d) interconnecting the connecting member of the safety harness and the connecting element of the connecting device.

14. The method of claim 13, further comprising:
a) matching a second indicator of a first portion and a third indicator of a second portion, the first portion and the second portion forming an internal connection of the safety harness; and
b) interconnecting the first portion and a second portion to secure and don the safety harness.

15. A safety harness for use with a connecting device including a connecting element being coded with a connecting element indicator, comprising:
a) a first shoulder strap configured and arranged to fit about a first shoulder of a user,
b) a second shoulder strap configured and arranged to fit about a second shoulder of the user;
c) a first leg strap configured and arranged to fit about a first leg of the user;
d) a second leg strap configured and arranged to fit about a second leg of the user; and
e) a dorsal pad assembly interconnecting said first shoulder strap and said second shoulder strap proximate a back of the user, said dorsal pad assembly including a D-ring configured and arranged to operatively connect with the connecting element of the connecting device, said D-ring being coded with a D-ring indicator, said D-ring indicator and the connecting element indicator indicating that said D-ring and the connecting element are to be interconnected.

16. The safety harness of claim 15, further comprising a first buckle portion and a second buckle portion, said first buckle portion being operatively connected to said first shoulder strap proximate a front of the user, said second buckle portion being operatively connected to said second shoulder strap proximate the front of the user, said first buckle portion being coded with a first indicator, said second buckle portion being coded with a second indicator, said first indicator and said second indicator indicating that said first buckle portion and said second buckle portion are to be interconnected to interconnect said first shoulder strap and said second shoulder strap.

17. The safety harness of claim 16, further comprising a chest strap interconnecting said first shoulder strap and said second shoulder strap, said first buckle portion and said second buckle portion operatively connected to said chest strap.

18. The safety harness of claim 16, further comprising a second D-ring operatively connected to said fist shoulder strap and said second shoulder strap proximate the front of the user, said second D-ring having a second D-ring indicator indicating that said second D-ring is to be interconnected with a second connecting element.

19. The safety harness of claim 15, further comprising a side D-ring operatively connected to the safety harness proximate a junction of said first shoulder strap and said first leg strap, said side D-ring having a side D-ring indicator indicating that said side D-ring is to be interconnected with a third connecting element.

20. The safety harness of claim 15, further comprising a shoulder D-ring operatively connected to the safety harness proximate the first shoulder strap, said shoulder D-ring have a shoulder D-ring indicator indicating that said shoulder D-ring is to be interconnected with a fourth connecting element.

21. The safety harness of claim 15, further comprising a first buckle and a second buckle, said first buckle being coded with a first indicator indicating that said first buckle is to be connected to said first leg strap, said second buckle being coded with a second indicator indicating that said second buckle is to be connected to said second leg strap.
